(19) United States
(12) Patent Application Publication
(10) Pub. No.: US 2002/0179892 A1
(43) Pub. Date: Dec. 5, 2002

(54) Apparatus for detaching/attaching wafer carrier lid

(76) Inventors: Hiroaki Saeki, Nirasaki-shi (JP); Hiroki Oka, Nirasaki-shi (JP); Yasushi Taniyama, Toyohashi-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/155,994

(22) Filed: May 29, 2002

(30) Foreign Application Priority Data
May 30, 2001 (JP) 2001-161558

(51) Int. Cl. B25B 25/00

(52) U.S. Cl. 254/222; 254/267

(57) ABSTRACT

An apparatus for detaching/attaching a lid of a wafer carrier includes a driving section for rotating a key member. The driving section includes a moving member horizontally movable by a driving source and a link mechanism to convert motion of the moving member into rotation of the key member. When a lock mechanism is to be locked, the driving section rotates the key member, which engages with an engaging member of the lock mechanism, to exceed a set angle by an extra angle, and then to return by the extra angle.

### CROSS-REFERENCE TO RELATED APPLICATIONS

This application is based upon and claims the benefit of priority from the prior Japanese Patent Application No. 2001-161558, filed May 30, 2001, the entire contents of which are incorporated herein by reference.

### BACKGROUND OF THE INVENTION

1. Field of the Invention

The present invention relates to an apparatus for detaching/attaching the lid of a wafer carrier placed at, e.g., the load port of a semiconductor processing system. The term “semiconductor process” used herein includes various kinds of processes which are performed to manufacture a semiconductor device or a structure having wiring layers, electrodes, and the like to be connected to a semiconductor device, on a target substrate, such as a semiconductor wafer or a glass wafer, by forming semiconductor layers, insulating layers, and conductive layers in predetermined patterns on the target substrate.

2. Description of the Related Art

A semiconductor processing system is provided with a load port for transferring wafers, such as semiconductor wafers, which are accommodated in a wafer carrier, into the semiconductor processing system. On that side of the load port, which faces the semiconductor processing system, there is an apparatus for detaching/attaching the lid of the wafer carrier. The detaching/attaching apparatus includes a key mechanism and a lid moving mechanism. The key mechanism is used for unlocking/locking a lock mechanism built in the lid of the wafer carrier. The lid moving mechanism is used for moving the unlocked lid away from/toward the main body of the wafer carrier.

In the detaching/attaching apparatus, when its key member is operated to pass through the key hole and engage with the engaging member of the lock mechanism to unlock the lock mechanism, there is a case where the operation does not go well. Accordingly, a problem arises such that a semiconductor process on the wafers stagnates.

### BRIEF SUMMARY OF THE INVENTION

An object of the present invention is to provide an apparatus of this kind, which allows the lid of a wafer carrier to be detached/attached without a hitch.

According to a first aspect of the present invention, there is provided an apparatus for detaching/attaching a lid of a wafer carrier, the lid including a lock mechanism, which has a key hole formed in a front face of the lid and an engaging member disposed in the key hole for driving a lock, the engaging member being rotatable between an unlocking position and a locking position, the apparatus comprising:

a lid holding plate having a portion that comes into contact with the front face of the lid;

a first driving section configured to move the lid holding plate and the wafer carrier back and forth relative to each other in a first direction perpendicular to the front face of the lid;

a key member projecting from the lid holding plate at a position corresponding to the key hole, and configured to engage with and rotate the engaging member, the key member having a dimension such that a clearance is provided between the key member and the engaging member; and

a second driving section configured to rotate the key member relative to the lid holding plate,

wherein the second driving section comprises,

a support plate rotatably supported by the lid holding plate and supporting the key member attached thereto,

a reciprocating member supported by the lid holding plate and configured to be moved in a second direction perpendicular to the first direction,

a link lever connecting the support plate to the reciprocating member and configured to convert reciprocation of the reciprocating member into rotation of the support plate, and

a driving source configured to reciprocate the reciprocating member, and

wherein the second driving section drives the key member, such that, when the lock mechanism is to be locked, the key member once reaches an over-drive position, which exceeds a position corresponding to the locking position by an angle corresponding to the clearance, and then rotates backward to return to the position corresponding to the locking position.

According to a second aspect of the present invention, there is provided an apparatus for detaching/attaching a lid of a wafer carrier, the apparatus comprising:

a lid holding plate movable back and forth in a horizontal direction perpendicular and relative to the lid of the wafer carrier placed on a load port; and

a key member rotatably supported by the lid holding plate, the key member being disposed to face a key hole of a lock mechanism built in the lid, and projecting from a front face of the lid holding plate,

wherein, when the lid is to be detached/attached, the key member engages with an engaging member of the lock mechanism through the key hole, and is rotated by a set angle to unlock/lock the lid, and then the lid holding plate is moved back and forth relatively in this state, and

wherein the apparatus comprises a driving section configured to rotate the key member, which includes a moving member horizontally movable by a driving source and a link mechanism to convert motion of the moving member into rotation of the key member, and, when the lock mechanism is to be locked, the driving section rotates the key member, which engages with the engaging member, to exceed a set angle by an extra angle, and then to return by the extra angle.

The lid of a wafer carrier is provided with a lock mechanism built therein, while a detaching/attaching apparatus for the lid is provided with a key mechanism built therein for unlocking/locking the lid by operating the lock mechanism. When the lid of the wafer carrier is to be detached, the lock mechanism in a locked state is unlocked by the key mechanism. Thereafter, when the lid is placed on the wafer carrier and to be locked, the key member, which engages with the engaging member of the lock mechanism in an unlocked state, is rotated by a set angle by a link mechanism, which is connected to a member horizontally movable by a driving source. Since there is a small clearance between the engaging member and the key member, the rotation angle of the engaging member may be smaller than the set angle when the key member is rotated by the set angle.

However, according to the first or second aspect of the present invention, the key member is rotated (over-driven) by the link mechanism, which is connected to the member horizontally movable by the driving source, to exceed a set angle by an angle corresponding to the clearance. Consequently, the engaging member is reliably rotated by the set angle. After being over-driven, the key member is rotated backward by the angle corresponding to the clearance, and is placed at a normal position, where the key member has been rotated by the set angle as a result. Accordingly, the next operations can be performed without a hitch when the key member is separated from the engaging member after the lock mechanism is locked, or when the key member is engaged with the engaging member to unlock the lock mechanism in the next step.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a side view showing a load port apparatus provided with a detaching/attaching apparatus for a wafer carrier lid according to an embodiment of the present invention;

FIG. 2 is a rear view showing the load port apparatus shown in FIG. 1;

FIG. 3 is a perspective view showing a relationship between a key mechanism built in the detaching/attaching apparatus shown in FIG. 1 and the lid of a wafer carrier;

FIG. 4 is a front view showing the key mechanism of the detaching/attaching apparatus shown in FIG. 1 in a state where it holds the lid;

FIG. 5 is a partially cutaway plan view showing the key mechanism of the detaching/attaching apparatus shown in FIG. 1;

FIG. 6 is a partially cutaway perspective view showing a wafer carrier for semiconductor wafers;

FIG. 7 is a partially cutaway front view showing the wafer carrier shown in FIG. 6;

FIG. 8 is a partially cutaway side view showing the wafer carrier shown in FIG. 6;

FIG. 9 is an enlarged front view showing the main part of a lock mechanism built in the wafer carrier shown in FIG. 6;

FIGS. 10A and 10B are sectional side views respectively showing a locked state and an unlocked state of the lid of the wafer carrier shown in FIG. 6;

FIGS. 11A to 11D are front views sequentially showing operations of the key rotation section of the detaching/attaching apparatus shown in FIG. 1, when the lid of the wafer carrier shown in FIG. 6 is to be locked; and

FIGS. 12A to 12D are front views sequentially showing operations of the lock mechanism of the lid, when the lid of the wafer carrier shown in FIG. 6 is to be locked.

### DETAILED DESCRIPTION OF THE INVENTION

In the process of developing the present invention, the inventors conducted research on the causes in an apparatus for detaching/attaching the lid of a wafer carrier, as to why a key member sometimes does not engage with the engaging member of a lock mechanism. As a result, the present inventors have obtained the findings given below. For the sake of convenience, an explanation will be given thereof, referring to part of an apparatus according to an embodiment of the present invention.

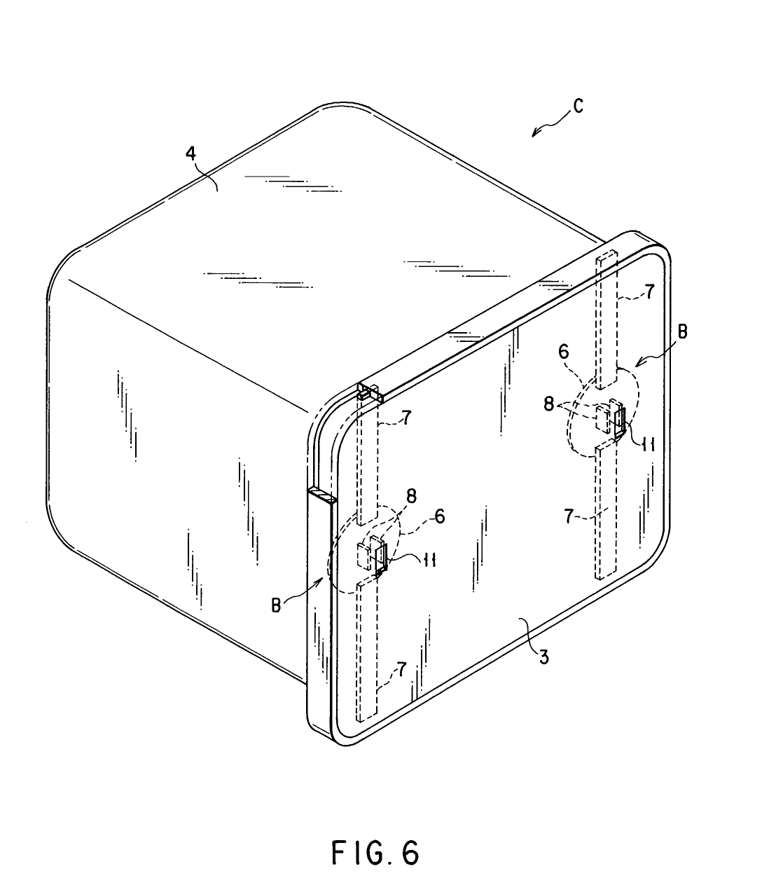

FIG. 6 is a partially cutaway perspective view showing a wafer carrier for semiconductor wafers.

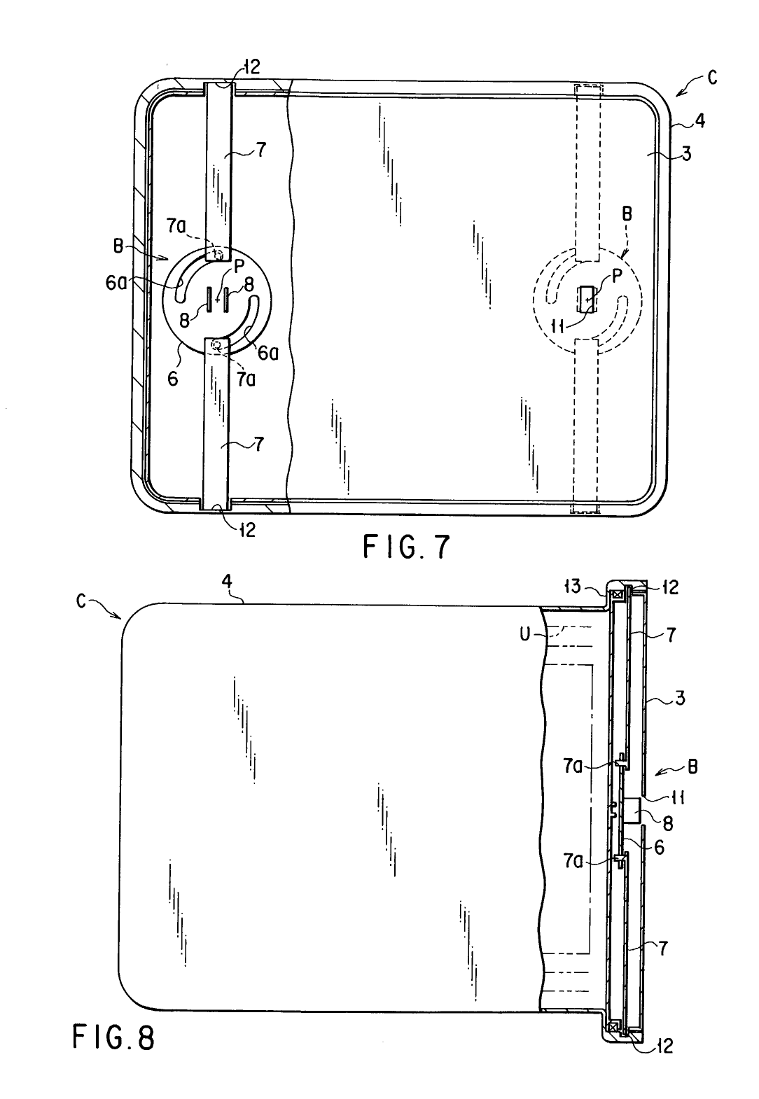

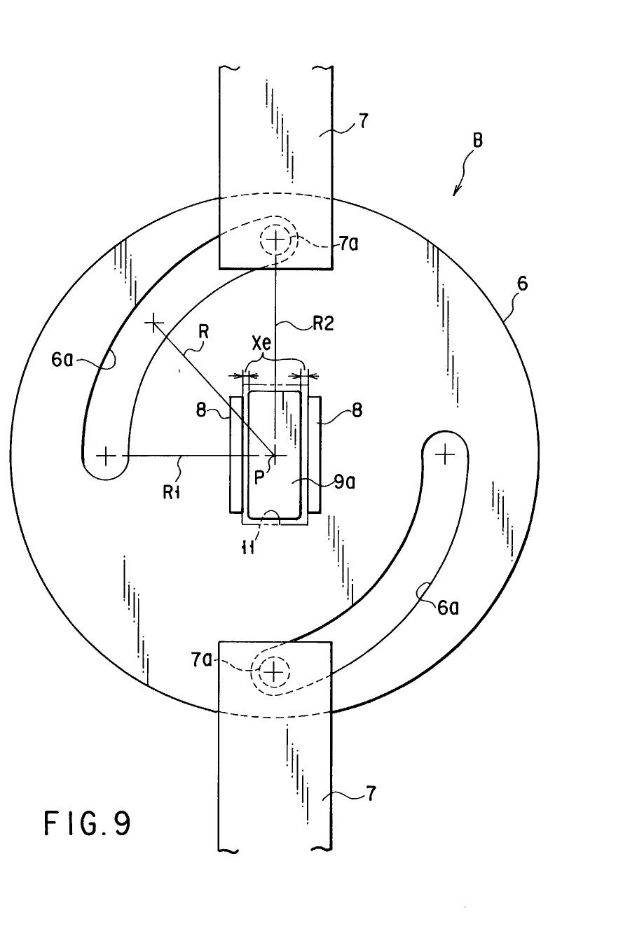

FIGS. 7 and 8 are a partially cutaway front view and a partially cutaway side view, respectively, showing the wafer carrier shown in FIG. 6. FIG. 9 is an enlarged front view showing the main part of a lock mechanism built in the wafer carrier shown in FIG. 6.

As shown in FIG. 6, the wafer carrier C includes a main body 4 formed of a rectangular container, and a lid 3 for closing the opening of the main body 4. The lid 3 is provided with a pair of lock mechanisms B built therein, one on either side in the width direction. Since the pair of lock mechanisms B have the same structure and operate synchronously, only one of the lock mechanisms B will be explained.

As shown in FIGS. 8 and 9, each lock mechanism B includes a circular disk 6, which is disposed near the center in the height direction of the lid 3, and is rotatable about a rotational center P. Two cam grooves 6a are formed in the disk 6 along angular directions. The cam center (not shown) of each cam groove 6a is set at a position shifted from the rotational center P of the disk 6. Accordingly, cam radiuses R1 and R2 of each cam groove 6a (distances from the rotational center P of the disk 6 to the opposite ends of the cam groove 6a) differ from each other. FIG. 9 shows that the cam radius R1 is smaller than the cam radius R2. Each cam groove 6a extends by an angle slightly larger than 90°.

As shown in FIGS. 8 and 9, a pair of lock plates 7 are-connected to the disk 6 on upper and lower sides respectively by connection pins 7a. Recesses 12 to respectively engage with the distal ends of the pair of lock plates 7 are formed in the main body 4 of the wafer carrier C, at positions corresponding to the distal ends of the upper and lower lock plates 7 (i.e., the upper end of the upper lock plate 7 and the lower end of the lower lock plate 7). In FIG. 8, reference symbol 13 denotes a rubber ring for airtightly sealing the lid 3 to the main body 4. The connection pin 7a is attached to the proximal end (the end on the disk 6 side) of each lock plate 7, and is inserted into the corresponding cam groove 6a of the disk 6. The connection pin 7a is moved along the cam groove 6a in accordance with rotation of the disk 6.

A pair of engaging projections 8 are disposed with a certain distance therebetween at the center of the front side of the disk 6. When the lock mechanism B is locked, the engaging projections 8 are placed at an almost vertical position. At a position corresponding to the engaging projections 8, the lid 3 is provided with a key hole 11 formed therein, to allow a latchkey 9a (the distal end of a key member 9 arranged on an apparatus A for detaching/attaching the lid 3, as described later) to be inserted into the lid 3. The key hole 11 has a width larger than the inner width between the pair of engaging projections 8.

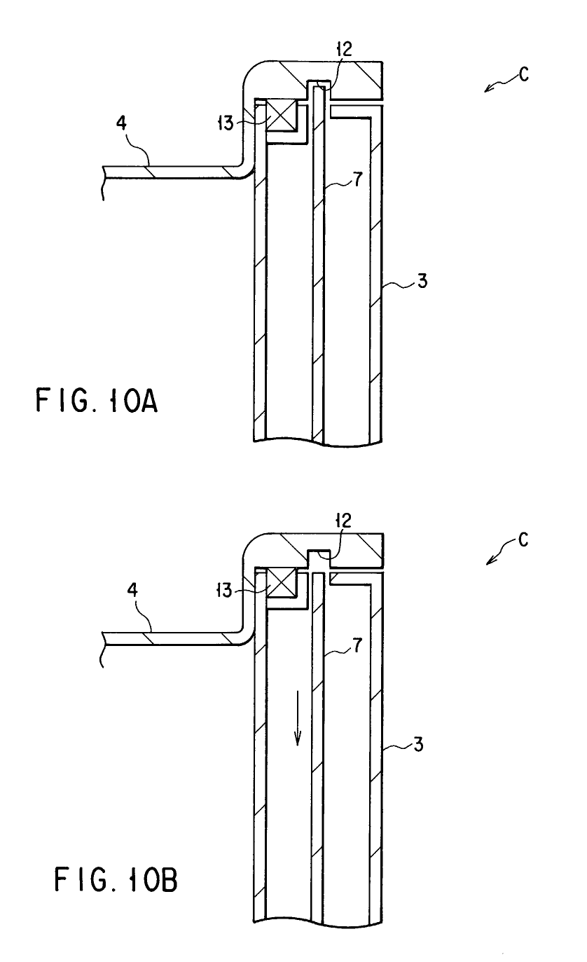

The lock mechanism B is locked when the distal ends of the upper and lower lock plates 7 respectively engage with the recesses 12 formed in the main body 4 of the wafer carrier C. FIG. 10A shows a state where the upper lock plate 7 engages with the recess 12 (i.e., a state where the lid 3 is locked). FIG. 10B shows a state where the upper lock plate 7 retreats from the recess 12 (i.e., a state where the lid 3 is unlocked).

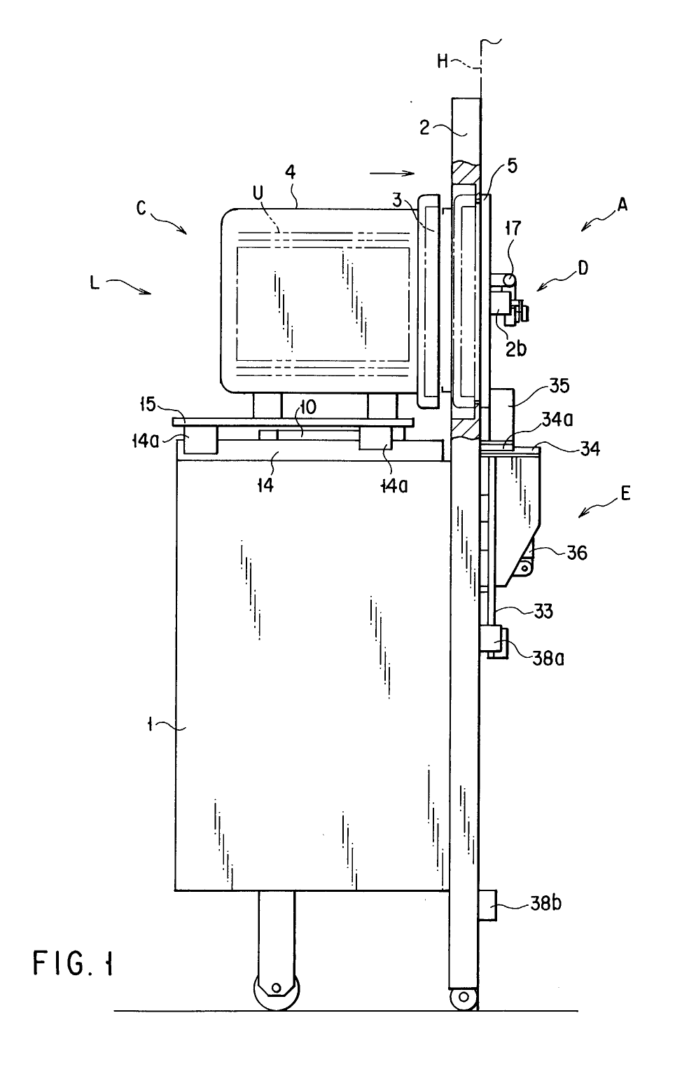

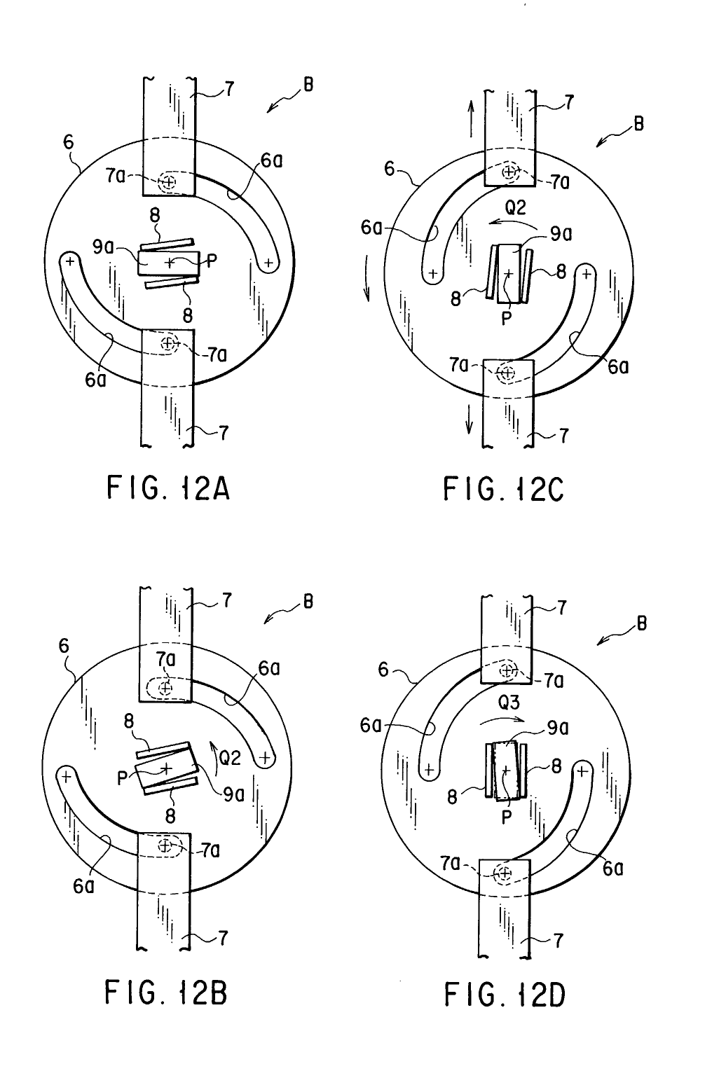

An explanation will be given of an operation of locking the lid 3 placed in an unlocked state. When the lid 3 is unlocked, the lid 3 is held by a lid holding plate 5 (see FIG. 1) arranged on the detaching/attaching apparatus A, as describe later. At this time, as shown in FIG. 12A, the pair of engaging projections 8 are placed at an almost horizontal position, and the latchkey 9a is placed in the gap between the pair of engaging projections 8.

As shown in FIGS. 12B and 12C, when the lid 3 is to be locked, the latchkey 9a is rotated counter-clockwise (in an arrow Q2 direction). With this operation, the cam radius R of the cam groove 6a gradually increases, so as to move the proximal ends of the upper and lower lock plates 7 away from each other. Consequently, the distal ends of the lock plates 7 respectively enter and engage with the recesses 12 of the main body 4, thereby locking the lid 3. When the lid 3 is to be unlocked, an operation reverse to that described above is performed.

As shown in FIG. 9, there is a small clearance Xe between each of the pair of engaging projections 8 and the latchkey 9a. Accordingly, when the lid 3 is to be locked, even if the latchkey 9a is rotated by 90°, the engaging projections 8 are not rotated to a normal position where they stand accurately vertical, but are inclined by an angle corresponding to the clearance Xe. FIG. 12C shows a state where the engaging projections 8 are inclined from the normal position, as described above.

After the latchkey 9a retreats from the pair of engaging projections 8, the wafer carrier C is transferred to the next step, while the engaging projections 8 remain inclined. As a result, when a latchkey 9a enters between the pair of engaging projections 8 to unlock the lid 3, the pair of engaging projections 8 may interfere with the latchkey 9a.

An embodiment of the present invention achieved on the basis of the findings given above will now be described with reference to the accompanying drawings. In the following description, the constituent elements having substantially the same function and arrangement are denoted by the same reference numerals, and a repetitive description will be made only when necessary.

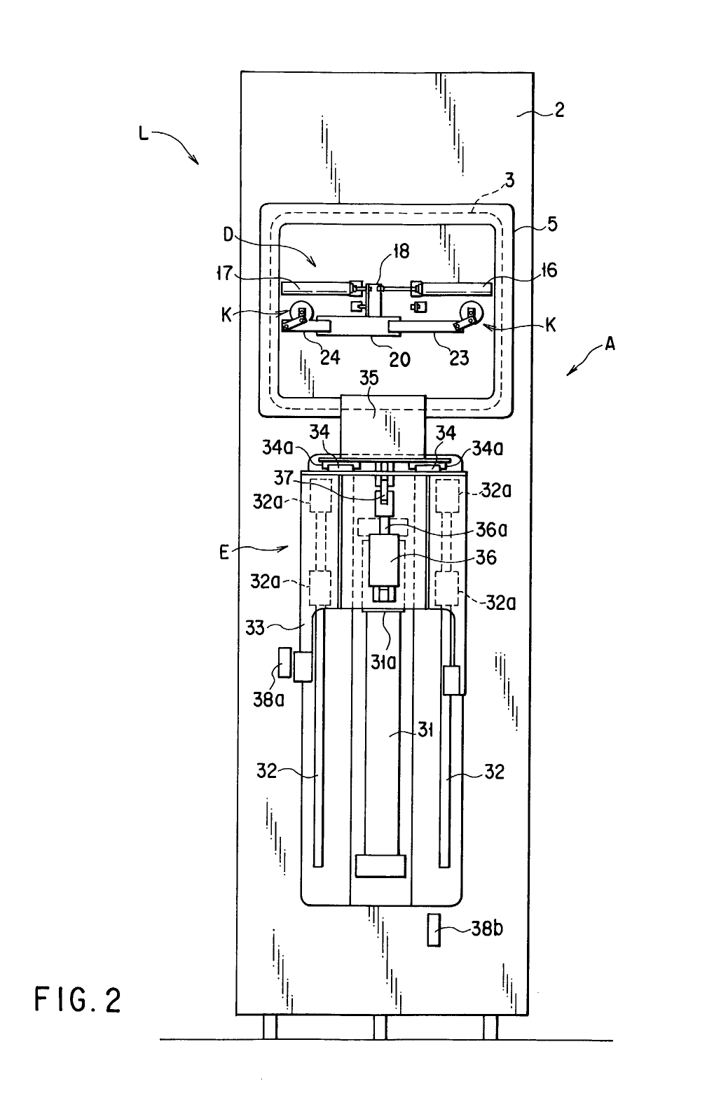

FIG. 1 is a side view showing a load port apparatus provided with a detaching/attaching apparatus for a wafer carrier lid according to an embodiment of the present invention. FIG. 2 is a rear view showing the load port apparatus shown in FIG. 1.

As shown in FIGS. 1 and 2, the load port apparatus L is used for transferring a number of wafers U, which are accommodated in a wafer carrier C placed on the top of a main body 1, into a semiconductor processing system (semiconductor manufacturing apparatus) H. On that side of the load port apparatus L, which faces the semiconductor processing system H, there is a mount plate 2 for integratedly mounting the load port apparatus L on the semiconductor processing system H. An apparatus A for detaching/attaching the lid 3 of a wafer carrier C is mounted on the mount plate 2.

The detaching/attaching apparatus A includes a key mechanism D and a lid moving mechanism E. The key mechanism D is used for unlocking/locking the lock mechanisms built in the lid 3 of the wafer carrier C. The lid moving mechanism E is used for moving the unlocked lid 3 away from/toward the main body 4 of the wafer carrier C, while holding the lid 3 on a lid holding plate 5.

The top of the main body 1 of the load port apparatus L is provided with guide rails 14 extending in a direction connecting the rear and the front. Sliders 14a engage with the guide rails 14, and support a table plate 15 disposed thereon for placing the wafer carrier C. The table plate 15 is connected to the cylinder rod (not shown) of a pneumatic cylinder 10. The wafer carrier C placed on the table plate 15 is horizontally moved by the pneumatic cylinder 10, so that it is moved away from/toward the lid holding plate 5. A state where the wafer carrier C is in close contact with the lid holding plate 5 is indicated with a two-dot-chain line in FIG. 1.

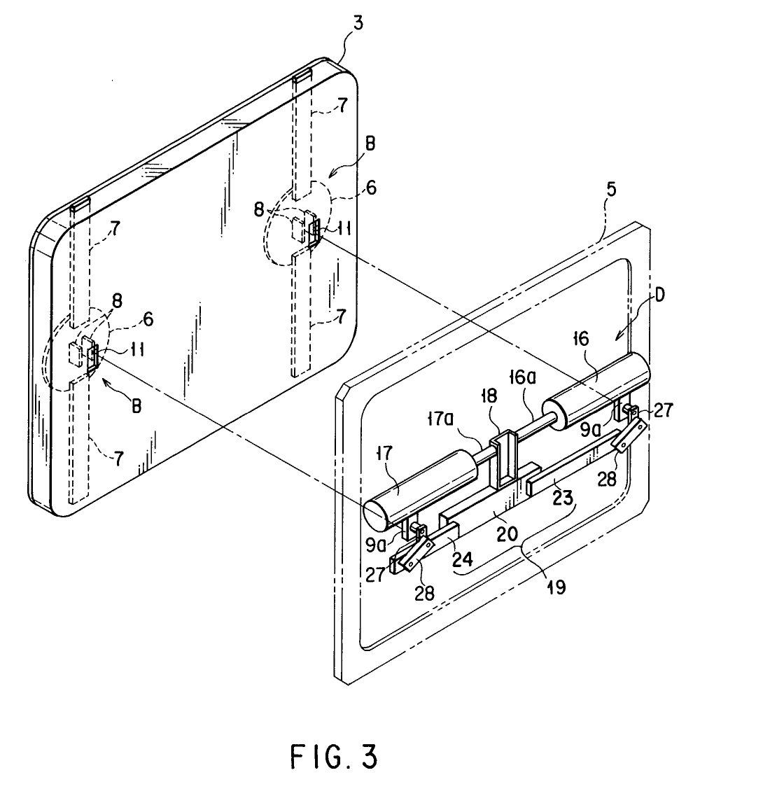

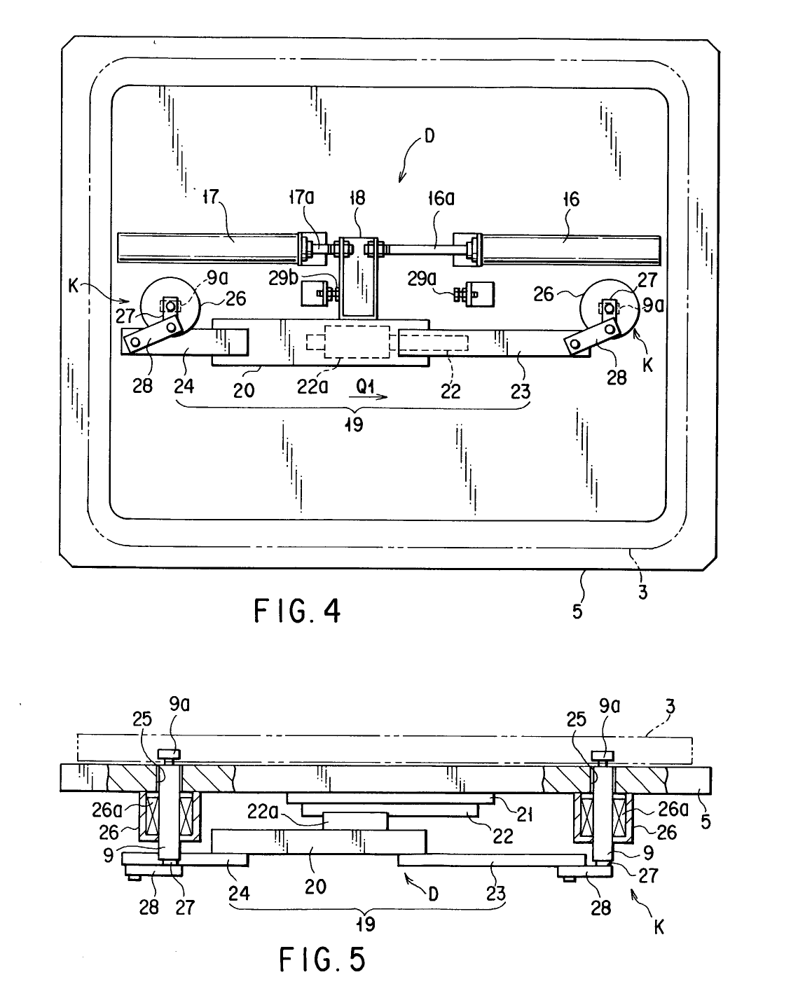

FIG. 3 is a perspective view showing a relationship between the key mechanism D built in the detaching/attaching apparatus A and the lid 3 of the wafer carrier C. FIG. 4 is a front view showing the key mechanism D of the detaching/attaching apparatus A in a state where it holds the lid 3 (i.e., the lock mechanisms B of the lid 3 are unlocked). FIG. 5 is a partially cutaway plan view showing the key mechanism D of the detaching/attaching apparatus A.

As shown in FIGS. 1 to 3, the lid holding plate 5 has a flat plate shape, which is slightly larger than the lid 3 of the wafer carrier C and disposed to face the lid 3. The key mechanism D of the detaching/attaching apparatus A for unlocking/locking the lid 3 of the wafer carrier C is arranged on the rear of the lid holding plate 5 (the semiconductor manufacturing apparatus H side). As shown in FIGS. 4 and 5, the key mechanism D includes a pair of pneumatic cylinders 16 and 17, which are disposed near the center of the lid holding plate 5 to extend in a horizontal direction and have distal ends facing each other. The distal ends of the cylinder rods 16a and 17a of the pneumatic cylinders 16 and 17 are connected to a connection bracket 18. The bottom of the connection bracket 18 is connected to a reciprocating member 19, which includes a central plate 20 and right and left connection plates 23 and 24.

A slider 22a is integratedly attached to the central plate 20 of the reciprocating member 19. The slider 22a engages with a guide rail 22 fixed to the lid holding plate 5 through a base 21. Accordingly, the reciprocating member 19 is movable in a horizontal direction along the guide rail 22. When the cylinder rod 16a (17a) of one of the pair of pneumatic cylinders 16 and 17 is extended, while the other cylinder rod 17a (16a) is withdrawn, the reciprocating member 19 is moved in the horizontal direction along the guide rail 22.

Key rotation sections K each including a key member 9 are respectively disposed at the distal ends of the connection plates 23 and 24 of the reciprocating member 19. Since the key rotation sections K have the same structure, only one key rotation section K on the connection plate 23 side (the right side in FIG. 4) will be explained. In the lid holding plate 5, a through hole 25, into which the key member 9 is inserted, is formed at a position facing the corresponding key hole 11 formed in the lid 3. On the rear side of the lid holding plate 5, a bearing casing 26 is attached at a position corresponding to the through hole 25. The bearing casing 26 contains a bearing 26a for rotatably supporting the key member 9. The distal end of the key member 9 is provided with a latchkey 9a, which has an almost rectangular cross section. The latchkey 9a projects from the surface of the lid holding plate 5 on the lid 3 side.

The rear side of the key member 9 extends out of the bearing casing 26, and is fixed to one end of a support plate 27 formed of a rectangular plate. The support plate 27 is arranged such that its longitudinal direction is perpendicular to the longitudinal direction of the latchkey 9a. The other end of the support plate 27 is connected to the distal end of the connection plate 23 of the reciprocating member 19 through a link lever 28. The connecting portion between the distal end of the connection plate 23 and the link lever 28, and the connecting portion between the support plate 27 and the link lever 28 are arranged to be rotatable about rotational centers CL1 and CL2, respectively. In other words, reciprocation of the reciprocating member 19 is converted into rotation of the key member 9 by a link mechanism including the link lever 28 as the main component.

When the cylinder rod 16a of the pneumatic cylinder 16 is extended, i.e., the latchkey 9a is positioned horizontally, the link lever 28 according to this embodiment extends slantingly upward from the connection plate 23 toward the right side. Stopper bolts 29a and 29b are disposed one on either side of the connection bracket 18 to define the reciprocation range of the reciprocating member 19. By adjusting the amount of project of the heads of the stopper bolts 29a and 29b, through screw portions the range of reciprocation of the reciprocating member 19 can be altered.

As shown in FIGS. 1 and 2, the lid moving mechanism E includes a rod-less cylinder 31 disposed on the mount plate 2 near the center in the width direction and extending in the height direction. A pair of guide rails 32 are disposed one on either side of the rod-less cylinder 31 and extend in the height direction. Sliders 32a engage with the guide rails 32. A bracket 33 is fixed to the sliders 32a and the movable portion 31a of the rod-less cylinder 31. The bracket 33 is movable in a vertical direction by driving the rod-less cylinder 31.

Two guide rails 34 are disposed on the top of the bracket 33 and extend in a direction connecting the rear and the front of the load port apparatus L. Sliders 34a engage with the guide rails 34. The lid holding plate 5 is attached to the top of the sliders 34a through a block 35. The lid holding plate 5 is movable in a direction connecting the rear and the front of the load port apparatus L by a pneumatic cylinder 36, which is attached almost along the height direction of the bracket 33, and a link mechanism 37 disposed at the distal end of the cylinder rod 36a of the pneumatic cylinder 36. In FIGS. 1 and 2, reference symbols 38a and 38b denote switches for detecting the upper end and the lower end of motion of the bracket 33, respectively.

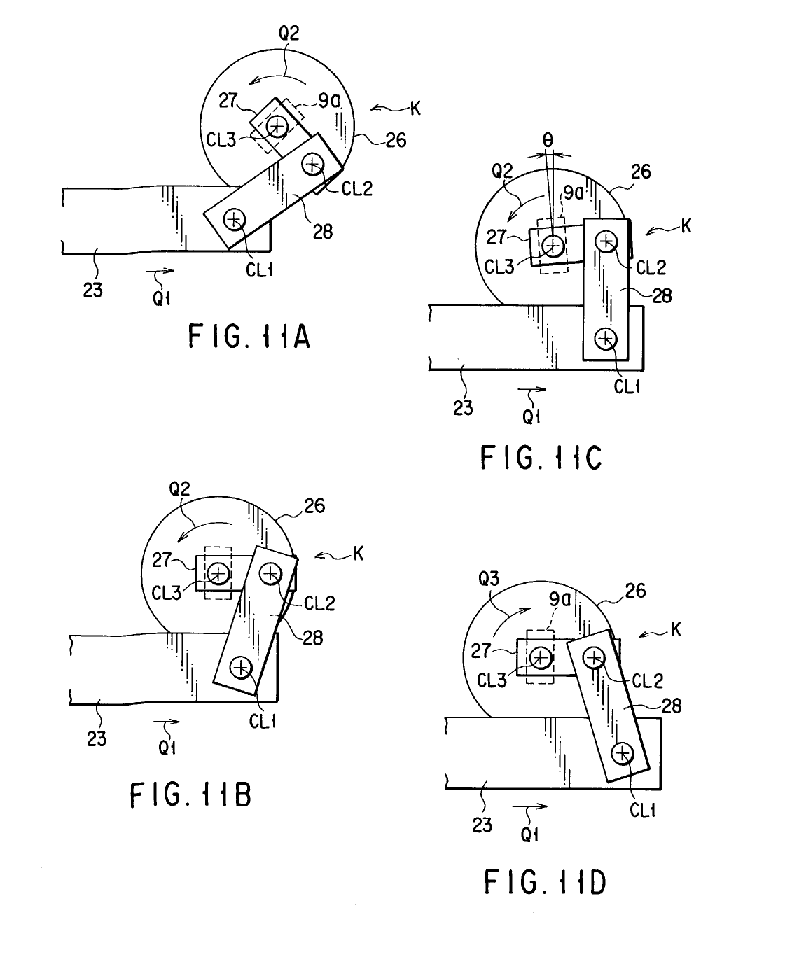

An explanation will be given of operations of the detaching/attaching apparatus A, according to an embodiment of the present invention. In this explanation, it is taken as an example that the lid 3 held by the lid holding plate 5 is to be placed on the wafer carrier C and locked. FIGS. 11A to 11D are front views sequentially showing operations of the key rotation section K of the detaching/attaching apparatus A, when the lid 3 of the wafer carrier C is to be locked. FIGS. 12A to 12D are front views sequentially showing operations of the lock mechanism B of the lid 3, when the lid 3 of the wafer carrier C is to be locked.

As shown in FIGS. 4, 5, and 12A, when the lid 3 is held by the lid holding plate 5, the latchkey 9a engages with the pair of engaging projections 8 of the lock mechanism B, and is placed in a horizontal state. Consequently, the longitudinal direction of the latchkey 9a is perpendicular to the longitudinal direction of the key hole 11 in this state, so that the latchkey 9a is prevented from coming off the key hole 11.

As shown in FIG. 1, the lid moving mechanism E is driven, so that the lid 3 held by the lid holding plate 5 is moved toward the wafer carrier C and is placed on the main body 4. Then, the key mechanism D is activated. More specifically, as shown in FIG. 4, the cylinder rod 17a of the pneumatic cylinder 17 is extended, while the cylinder rod 16a of the pneumatic cylinder 16 is withdrawn. With this operation, the reciprocating member 19 is moved horizontally in an arrow Q1 direction, while being guided by the guide rail 22. At this time, each of the key rotation sections K operate as follows.

Specifically, as shown in FIG. 11A, along with the horizontal movement of the reciprocating member 19, the connection plate 23 is also moved horizontally in the arrow Q1 direction. The lower end of the link lever 28 is connected to the distal end of the connection plate 23, such that the link lever 28 is rotatable about the rotational center CL1. The lower end of the support plate 27 is connected to the upper end of the link lever 28, such that the support plate 27 is rotatable about the rotational center CL2. As shown in FIG. 5, the upper end of the support plate 27 is fixed to the proximal end of the key member 9, which is supported only rotatably by the bearing 26a in the bearing casing 26. Accordingly, as the connection plate 23 is moved in the arrow Q1 direction, the key member 9 is rotated counterclockwise (in the arrow Q2 direction) about a rotational center CL3 (the axial center of the key member 9). As a result, the latchkey 9a is also rotated in the same direction.

As shown in FIG. 9, there is a small clearance Xe between each of the pair of engaging projections 8 and the latchkey 9a. Accordingly, the disk 6 is rotated with a delay corresponding to the clearance Xe, when the latchkey 9a is rotated. As a result, even when the reciprocating member 19 is moved horizontally in the arrow Q1 direction and the latchkey 9a is rotated 90° to come to the vertical position, the engaging projections 8 are not rotated to the normal position where they stand accurately vertical, but are inclined by an angle corresponding to the clearance Xe.

However, in the key mechanism D according to this embodiment, the reciprocating member 19 is not stopped here, but is further moved horizontally. Consequently, as shown in FIGS. 11C and 12D, the latchkey 9a is rotated in the arrow Q2 direction, and reaches an over-drive position, when the longitudinal direction of the connection plate 23 becomes perpendicular to the longitudinal direction of the link lever 28. The over-drive position is designed such that the latchkey 9a is over-driven by an angle (an extra angle θ) corresponding to the clearance Xe formed between the pair of engaging projections 8 and the latchkey 9a. As a result, the engaging projections 8 rotated by the latchkey 9a are placed at the normal position where they stand accurately vertical. The clearance Xe is set to fall within a range of about 0.1 to 0.3 mm on the basis of the standard of the wafer carrier C, while the latchkey 9a rotates from the vertical position to the over-drive position by an angle of about 2 to 3°.

After the latchkey 9a reaches the over-drive position, the reciprocating member 19 is further moved horizontally in the arrow Q1 direction. Consequently, the link lever 28 is inclined in a direction opposite to the former direction, and the latchkey 9a is rotated backward or in reverse (clockwise; in an arrow Q3 direction). As shown in FIG. 11D, when the connection plate 23 reaches the forward end position (i.e., when the connection bracket 18 comes into contact with one 29a of the stopper bolts in FIG. 4), the latchkey 9a is returned to the vertical position.

As shown in FIG. 12D, when the latchkey 9a is rotated in the arrow Q3 direction, the rotation of the latchkey 9a is performed within the clearance Xe relative to the pair of engaging projections 8. Accordingly, in spite of the rotation of the latchkey 9a, the engaging projections 8 remain at the normal position. When the latchkey 9a is returned to the vertical position, the relationship between the engaging projections 8 and the latchkey 9 is as shown in FIG. 9 (the latchkey 9a in this state is also shown in FIG. 12D with a two-dot-chain line).

With the sequence described above, the lid 3 put on the main body 4 is locked. Then, the pneumatic cylinder 10 of the load port apparatus L is activated, so that the wafer carrier C is moved backward. At this time, the latchkey 9a is positioned at the accurately vertical position, it can be separated from the lid 3 as it is, through the key hole 11. Then, the wafer carrier C is transferred to the next step, while the engaging projections 8 are placed at the normal position where they stand accurately vertical. Accordingly, in the next step, when another latchkey 9a enters between the pair of engaging projections 8 to unlock the lid 3, the engaging projections 8 do not interfere with the latchkey 9a.

The over-drive and reverse rotation of the latchkey 9a is performed via the link mechanism including the link lever 28, while the reciprocating member 19 is moved only in one direction. In addition, the rotational steps of the latchkey 9a are performed by a single operation. Accordingly, the structure of the key mechanism D can be very simple. Furthermore, the pneumatic cylinders 16 and 17 are used as a driving source for the link mechanism. This makes the structure of the key mechanism D inexpensive.

In the embodiment described above, in place of the engaging projections 8, an opening or recess may be used as an engaging member of the lock mechanism B to engage with the latchkey 9a. Furthermore, in the embodiment described above, the lid 3 is detached/attached from/to the wafer carrier C by moving the lid holding plate 5 away from/toward the wafer carrier C placed in a stationary state. Alternatively, the lid 3 may be detached/attached from/to the wafer carrier C by moving the wafer carrier C by the pneumatic cylinder 10 away from/toward the lid holding plate 5 placed in a stationary state.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for detaching/attaching a lid of a wafer carrier, the lid including a lock mechanism, which has a key hole formed in a front face of the lid and an engaging member disposed in the key hole for driving a lock, the engaging member being rotatable between an unlocking position and a locking position, the apparatus comprising:
a lid holding plate having a portion that comes into contact with the front face of the lid;
a first driving section configured to move the lid holding plate and the wafer carrier back and forth relative to each other in a first direction perpendicular to the front face of the lid;
a key member projecting from the lid holding plate at a position corresponding to the key hole, and configured to engage with and rotate the engaging member, the key member having a dimension such that a clearance is provided between the key member and the engaging member; and
a second driving section configured to rotate the key member relative to the lid holding plate,
wherein the second driving section comprises,
a support plate rotatably supported by the lid holding plate and supporting the key member attached thereto,
a reciprocating member supported by the lid holding plate and configured to be moved in a second direction perpendicular to the first direction,
a link lever connecting the support plate to the reciprocating member and configured to convert reciprocation of the reciprocating member into rotation of the support plate, and
a driving source configured to reciprocate the reciprocating member, and
wherein the second driving section drives the key member, such that, when the lock mechanism is to be locked, the key member once reaches an over-drive position, which exceeds a position corresponding to the locking position by an angle corresponding to the clearance, and then rotates backward to return to the position corresponding to the locking position.

2. An apparatus according to claim 1, wherein, when the lock mechanism is to be locked, the reciprocating member is moved only in one direction, and the over-drive position corresponds to a state where the link lever is positioned perpendicular to the reciprocating member.

3. An apparatus according to claim 2, further comprising a stopper configured to determine an end point of motion of the reciprocating member.

4. An apparatus according to claim 3, wherein the stopper includes a screw portion for adjusting the end point of motion of the reciprocating member.

5. An apparatus according to claim 1, wherein the first driving section moves the lid holding plate away from and toward the wafer carrier placed in a stationary state.

6. An apparatus according to claim 1, wherein the first driving section moves the wafer carrier away from and toward the lid holding plate placed in a stationary state.

7. An apparatus for detaching/attaching a lid of a wafer carrier, the apparatus comprising:
a lid holding plate movable back and forth in a horizontal direction perpendicular and relative to the lid of the wafer carrier placed on a load port; and
a key member rotatably supported by the lid holding plate, the key member being disposed to face a key hole of a lock mechanism built in the lid, and projecting from a front face of the lid holding plate,
wherein, when the lid is to be detached/attached, the key member engages with an engaging member of the lock mechanism through the key hole, and is rotated by a set angle to unlock/lock the lid, and then the lid holding plate is moved back and forth relatively in this state, and
wherein the apparatus comprises a driving section configured to rotate the key member, which includes a moving member horizontally movable by a driving source and a link mechanism to convert motion of the moving and a link mechanism to convert motion of the moving member into rotation of the key member, and, when the lock mechanism is to be locked, the driving section rotates the key member, which engages with the engaging member, to exceed a set angle by an extra angle, and then to return by the extra angle.

8. An apparatus according to claim 7, wherein, when the lock mechanism is to be locked, the driving section moves the moving member only in one direction.

9. An apparatus according to claim 7, wherein the driving source comprises a pneumatic cylinder.
